(19) United States
(12) Patent Application Publication
(10) Pub. No.: US 2002/0107895 A1
(43) Pub. Date: Aug. 8, 2002

(54) Interactive personalized book and methods of creating the book

(76) Inventor: Barbara Timmer, Washington, DC (US)

Correspondence Address: BARNES & THORNBURG, 2600 CHASE PLAZA, 10 LASALLE STREET, CHICAGO, IL, 60603

(21) Appl. No.: 09/928,465

(22) Filed: Aug. 13, 2001

Related U.S. Application Data
(60) Provisional application No. 60/227,835, filed on Aug. 25, 2000.

(51) Int. Cl. G06F 17/24; G06F 17/60

(52) U.S. Cl. 707/530; 705/27

(57) ABSTRACT

A personalized book includes content of a user's choice, including streaming video and interactive content, in a structure designed by the user. The user completes questions and then a host can automatically find and offer related content to the user. The end product can be accessed from any location, provided access is available to the host in electronic media, at any time. The invention integrates technology provided by the host with constantly changing content selected by the user. Content can come from the user, the host, the host's Content Partners or any third party.

The resulting “book” can be static or interactive; saved forever or modified constantly; private or shared, stored on electronic media or printed. This invention allows a user to do more than read a book; the user actually creates the book. Moreover, the book generally relates directly and personally to the user's life.

### BACKGROUND OF THE INVENTION

This application claims priority to U.S. Ser. No. 60/227,835 filed Aug. 25, 2000.

The present invention relates to the gathering, cataloging, chronicling and presenting of personal information. This invention provides a method and structure for an individual user of electronic media to create a personalized interactive book with content chosen from either a “host” or from outside sources. The book may be sorted on a secure server, and may always be accessible and available online through electronic media, e.g. the Internet or a wireless application.

Many companies now offer static books online. The hypertext documents, often called “Web pages” in this context, are all the same for each reader (user), who simply downloads the pages onto a “player” or reads (scrolls) online. However, individual users are currently unable to create a personalized interactive book that uses the electronic media to access content archives of the user's choice and compile selected content in a structure of the user's choice.

### SUMMARY OF THE INVENTION

This invention is directed toward production of a personalized book by users of electronic media. A “host” is the portal means for a user to access information in electronic format. Such information, which will comprise the content of the book, may be supplied by the host, by Content Partners, by the user, or by any third party entity. The particular information that will comprise the content of the user's personalized book is then selected from any of the above mentioned sources, manipulated, and compiled in a book under the direction of the user. Consequently, each book is a personalized compilation of information that is useful for achieving goals of the user.

This invention offers each user the ability to create a personalized book or books that include the content the user chooses and is (are) built on a structure the user designs. The content may include, for example, traditional Web pages, digital pictures, audio and streaming video and “interactive” management, “quizzes” and/or personal empowerment “tools”.

The invention is based on an individual user's choices. Those choices determine the structure and, the overall content of the resulting book. In addition, the user can choose interactive tools, for example in a question and answer format, that will focus automatic searches for additional appropriate content.

The user can opt in for emails that update content or alert the user to changing information. The user's choices may include product purchases or related eCommerce opportunities.

The invention integrates technology provided by a host with constantly changing content selected by the user. The resulting “book” may be static or interactive, is accessible from any location where the user has the appropriate hardware and access capability, may be saved indefinitely and modified at any time. The book may be private (confidential) or shared. It may be updated regularly and chronologically, stored in an archive, or compared with a subsequent volume to track changes over time. This allows users to document evolution of their personalities over time as evidenced by responses to advice from experts and their comparison of quizzes and results. Monitoring of diet and nutrition modification and results on health and fitness is also facilitated.

This invention allows an individual “user” to do more than read a book that already exists. The user actually creates a book relating to his/her own life. The invention provides users with the ability to record and guide their own physical or emotional transformations over time, or collect and archive content that reflects a specific period of time of their lives. An on-line personal history diary, and evolution off personality and life style is possible.

Regular emails alert the user to new content they might want to add, or new videos available for viewing. The invention includes word processing capacity, the ability to create charts and calendars, email, and comprehensive storage capacity, and a variety of other integrated software programs. The invention includes the capacity to create, use, edit, retrieve, and save words, pictures, video and audio clips. It offers messaging and reminder calendars, shared mail, personalized email, and chatrooms and bulletin boards where users “authors” meet other authors or share their contents. By providing access to information that already exists in electronic format, the invention saves a user from creating a book completely from scratch.

The invention includes the ability to create and update, for example, a customized Table of Contents and an index, as well as compile, archive, search and organize in many different manners, all the imported content.

The book may be saved and downloaded on a user's own computer, or, particularly if the amount of information becomes so great that it overwhelms an individual's storage capacity, may be saved to some other storage device, such as the host's server and storage facility. In addition, print options currently available for online publishing, are suitable if hard copies are preferred.

### BRIEF DESCRIPTION OF THE DRAWINGS

FIG. 1 is a flow chart illustrating the overall scheme of the invention. Here the “user” becomes an “author” of the book, and enters personally identifiable information (“PII”) into an “author” data book, including computing capacity, broad band capacity, hardware and software capacity. Capacity may be purchased.

FIG. 2 shows that the host now makes first choices from categories such as language, age, gender and geography (Topicᵢ) wherein i=1, n and n is the number of topics.

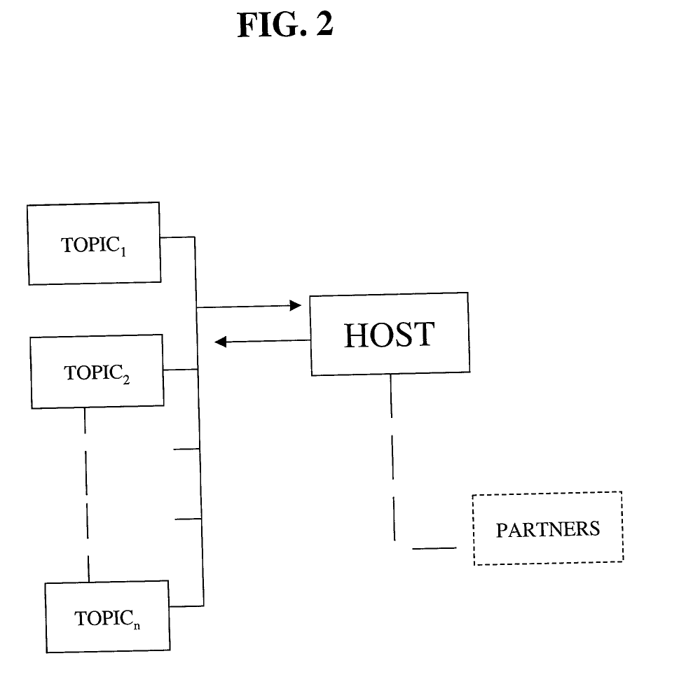

FIG. 3 shows examples of topics received by, than selected by a user.

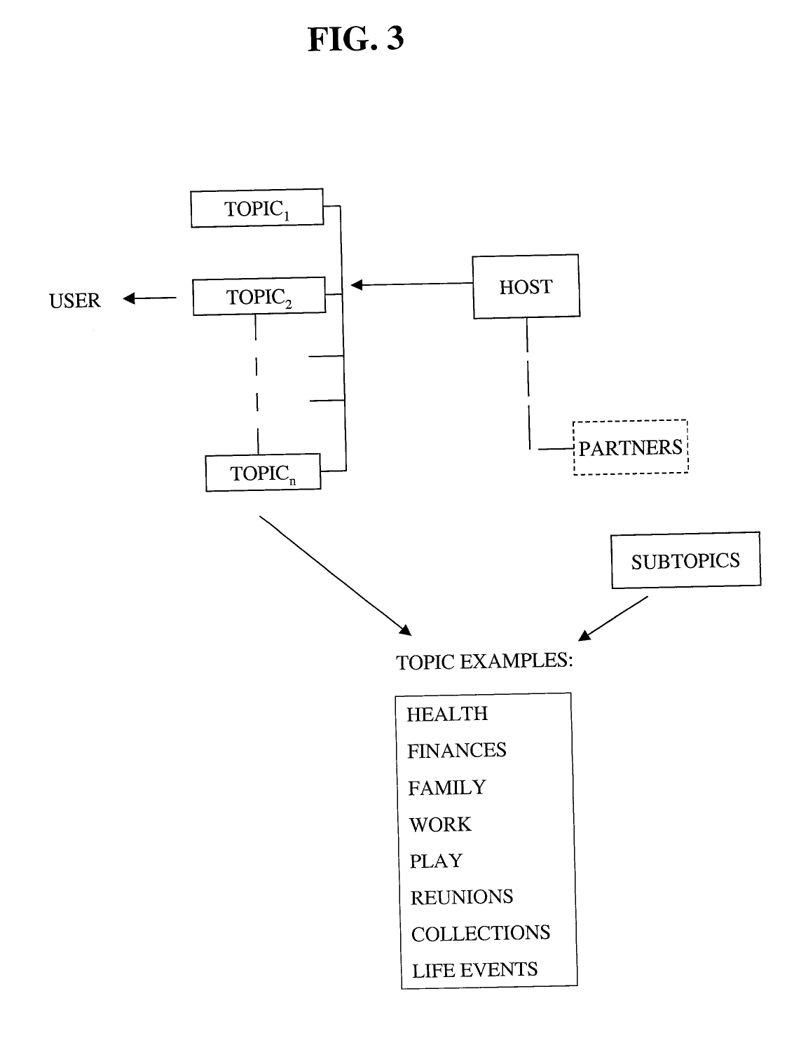

FIG. 4 shows that a user receives choices and recommendations for a book structure, and selects a structure; structure recommendations are partly dependent on prior selection (choices) of topics; structure choices may lead to product/purchase recommendations.

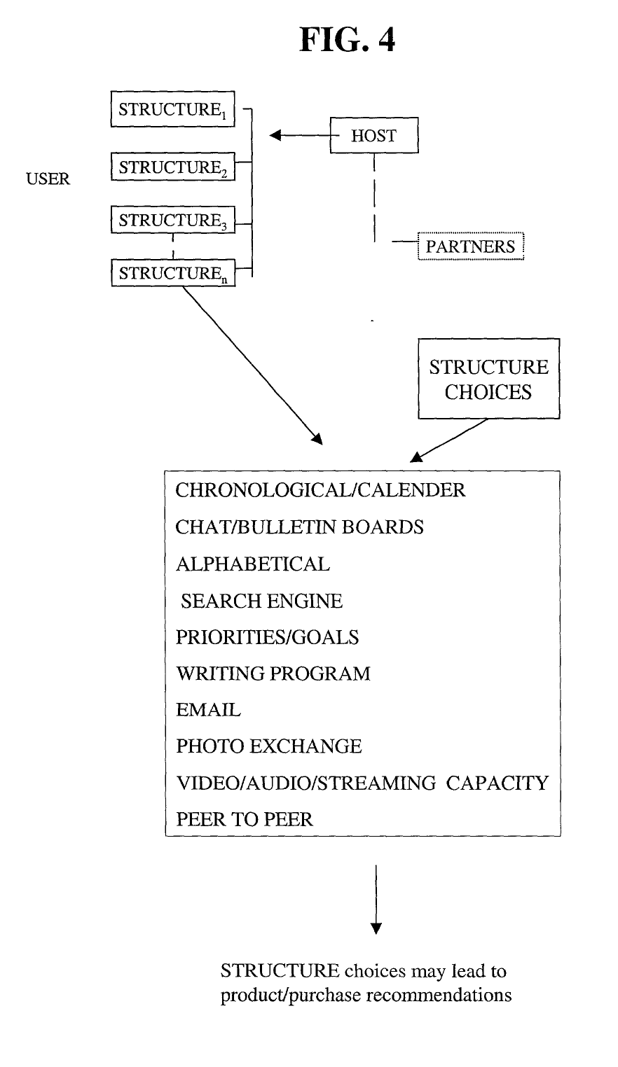

FIG. 5 shows that after the user selects from both menus (structure and content) a “first draft” of the personalized book is compiled. The “first draft” (or “first edition”) is then saved; the first draft will generally include some questions that need to be refined; a user may choose a structure that will be modified on an ongoing basis, or may choose to receive ongoing content updates which may be incorporated into subsequent drafts.

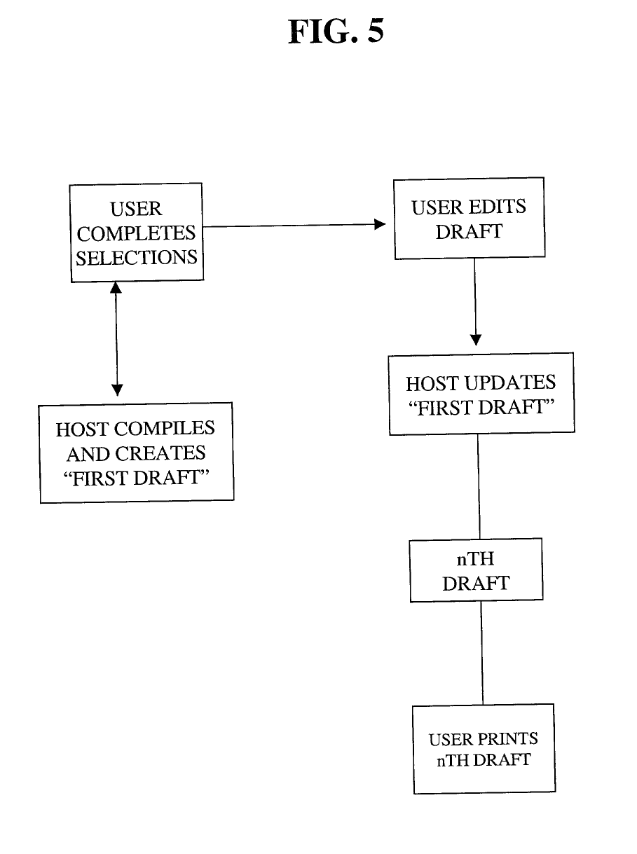

### DETAILED DESCRIPTION OF THE INVENTION

The present invention is directed to an apparatus, method, and program for selecting, creating, arranging, compiling, archiving, displaying and outputting a book.

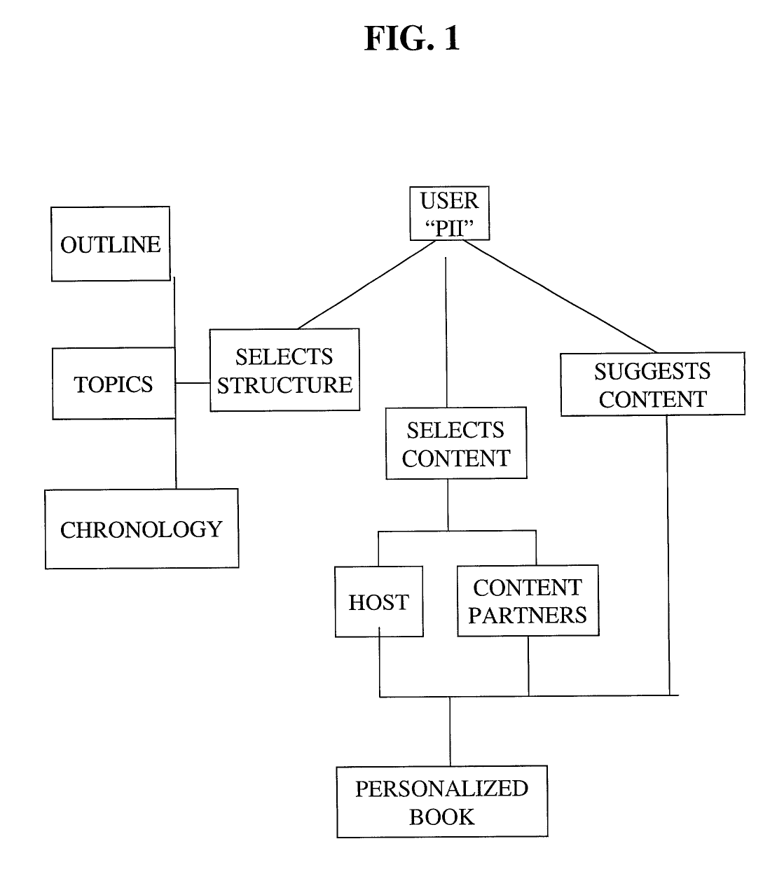

FIG. 1 is an overall system block diagram of one embodiment of the present invention. In this embodiment of the system the invention integrates technology which may be provided by a host with content selected by a user to create a personality book. Various aspects of the present invention, such as the theory and operation of networks and the Internet, are found in U.S. Utility application Ser. No. 09/632,297, and corresponding PCT Application PCT/US00/21289, which are now incorporated by reference. The host may be any apparatus capable of storing, manipulating and outputting information. For example, the host may be a single personal computer configured with any one of a plurality of commercially available software including integrated office suites, such as Microsoft Office, Lotus Notes or Enable, or database software such as Sybase, Fox Base, or dBase, or word-processing software such as Word or WordPerfect. The host could also be a personal digital assistant (“PDA”), such as a Palm, or any other type of apparatus capable of storing, manipulating, and displaying information that will form the content of the personality book. The host could likewise be a server in a local area network (“LAN”), a wide area network (“WAN”), an Internet-based network, or any other configuration of apparatuses, computers or information systems. Such networks, apparatuses, computers, and systems may be custom built or may consist of standard, commercially available hardware and software. Moreover, the present invention is independent of network architecture, hardware, and software.

The present invention contemplates development tools designed to assist the user in providing structure, content, and output of the personalized book. Such tools may be resident on the host, on the user's interface means, or on some other device remote from both the host and the user's interface device.

The user interface means may take any number of forms, and is the means by which the user interfaces with the host. If the host is a stand-alone personal computer, then the user interface means might be the computer's input device(s), such as a keyboard or voice recognition apparatus. The user interface means with stand-alone host could be through a link with, for example, a PDA or a laptop computer. If the host is a network, of any type, then the user could interface with the host through the network architecture, say from a remote computer or other device compatible with whatever type of network architecture is involved.

At some point in the process, the user selects the structure for the personalized book. This may be the first step, an intermediate step, or the last step in the process. In fact, the user may alter the structure of the book at any time. The structure may be free form, or it may be selected by a structure tool resident on the host. The structure tool assists the user in deciding from among a plurality of predefined structures, which may include, for example, an outline format, a “bucket” format, a topical format, a chronological format, or any other type of relational format.

An initial step in creating a personalized book includes populating the book with information, or content, which may include certain personal information such as life events (Table 1) factual background, Web pages, digital pictures, audio, streaming video, interactive modules, poetry, prose, quizzes, documents, and any other information deemed suitable by the user. The content can come from any number of sources, including directly from the user, and the nature and source of the content may be facilitated by any one or more of a plurality of content tools. Such content tools may include, for example, a personal-content tool, a legal-advisor tool, a personal-fitness tool, a financial-advisor tool, a nutritional-advisor tool, and a wine-connoisseur tool.

As noted, the content may be entered by the user directly, or selected from any number of sources including the host, the host's plurality of Content Partners, and third parties. The content may be static or interactive, saved without change or modified, private or shared. What is preferred, as illustrated by the examples below, is that the invention “recognizes” the user's choices and makes intelligent suggestions to enhance the user's experience as well as the end product itself, the book.

In the case of personal information, for example, the user could fill out a static template resident on the host, or could answer questions asked by the personal-content tool resident on the host, or could provide the information to the administrator of the host for manual entry into a database. Life events may include such things as births, marriages, deaths, and the like (Table 1); however, any information determined to be pertinent by the user can comprise the content. In addition, the personal-content tool, can offer suggestions to the user on what might be appropriate content. For example, if the user enters information that the user's grandfather died during D-Day in World War II, the personal-content tool might suggest several articles, pictures, videos, and Web sites chronicling D-Day that the user might want to consult for educational purposes. The user then could synthesize into the user's own words for inclusion in the book any information learned from these sources, could choose to include in the book hyperlinks to these sources, could directly import into the book selected information, in whole or in part, from these sources, or any combination of the foregoing. The personal-content tool would then import the selected content into the book from whatever the respective source of the content. The personal-content tool might also ask the user whether the grandfather earned any decorations as a result of his actions during D-Day and suggest that any such citations be scanned into the book. Similarly, the personal-content tool might suggest that the deceased's death certificate and War Department's death-notification letter be obtained and imaged. The personal-content tool could even provide advice on where such information could be obtained, for example, by providing the address to the National Archives, the Veteran's Administration, and the Department of Defense. If the grandfather died of cancer, the personal-content tool might suggest for inclusion background material on the particular cancer in the same manner as described in conjunction with the D-Day example.

The personal-content tool could also advise the user on various consequences and requirements based on the personal data. For example, if the user's personal information indicates that the user is an eighteen-year-old male whose father died of heart disease at age 55, one of the other plurality of content tools, such as the legal-advisor tool, the personal-fitness tool, and the financial-advisor tool, might each take this information from the personal-content tool and advise the user that he must register with the selective service, that he has a hereditary risk of heart disease, that he is in the age group at risk of testicular cancer, that he should follow certain preventative protocols, that he should consult with a physician, and that he should consider opening an Individual Retirement Account. Each content tool, in addition to providing suggestions and recording the information in the appropriate place, would also direct the user to further sources of information and content.

The selected content is manipulated by the user to fit the structure of the book and to fill the needs of the user. The resulting book or books may be stored on any media capable of storing such information and may also be output to a plurality of devices, including, but not limited to, computer screens, televisions, PDAs, printers, electronic pagers, cellular telephones, and electronic books such as The Rocket eBook. In addition, the resulting book might be a single, all-inclusive book, or it might take the form of one or more specific books, such as a MYLIFEBOOK, a MYTRAVELBOOK, a MYMONEYBOOK, a MYFOODBOOK, a MYWINEBOOK, or a MYPERSONALTRAINERBOOK, as illustrated below.

### EXAMPLES

It can be appreciated from the above description and examples that the invention contemplates the creation of myriad combinations and permutations of books, with content drawn from many sources and taking varied forms and formats, limited only by the user's imagination. The following examples are illustrative of the invention, not limiting.

### Example 1

### MYLIFEBOOK

A user selects life management content focused on the particular life events described in their personalization process (the process of providing personal information when the user first begins the book). The user also chooses from among various formats or structures to organize the book. The content of the book may include documents by well known experts on specific life events, such as death of a parent or spouse; suggested readings; and/or a daily motivational guide. Email capacity, and access to the host's software that allows the user to participate in “chats” with experts on topics they choose, provides interaction. The email function alerts the user any time new material is available for categories that the user has chosen. Transcripts of charts may be saved providing the ability to view interviews with those experts.

The content of the book of the present invention may be structured in a personally valuable style, that is, for example, either chronologically, by topic, or by a combination of the two. Other choices are only limited by the users′ imagination and goals.

### Example 2

### MYTRAVELBOOK

A user selects content from the host and/or imports content from other sites, and saves it in a travel planning scrapbook that already includes destination searching and trip planning ability, email and photography storage and transmittal ability, the ability to make and confirm reservations (and evaluate those reservations as the trip progresses!), reviews of restaurants available for each destination the author has selected, and sites of interest. The author receives emails about related products, from travel clothes to tickets to books or videos, and may read the reviews, buy the book or video (and even send in their own reviews!) The author accesses the MyTravelBook as the trip progresses, adds comments, makes changes and gets updated weather for the next day. During the day a user can keep up to date through their wireless application with weather, access email or change hotel reservations. A user may download digital pictures from the day and send them via email to friends. The travel planning guide becomes a scrapbook by the end of the trip! Another option is that scrapbooks may be made available and shared according to the user's choice with other travelers who are taking similar trips.

### Example 3

### MYMONEYBOOK

A user selects content from a source such as the host, including tools and interactive quizzes that help the user identify goals and strategies for financial planning and management. The user may elect to be updated regularly on everything from individual stocks to interest rates to the latest business news. The user can aggregate all their financial information on an ongoing basis using the host's aggregator tool; may import and save tools for finding appropriate mortgage rates or loan quotes; may add a calendar with financial goals; and/or may search the host's extensive archives for content on financial management. Users may join regular bulletin board chats to hear from financial experts, and save the information in their book; search the extensive video library for relevant videos and import the ones they want for their regular use or personal archives.

### Example 4

### MYFOODBOOK

Users access and save selected content on nutrition, recipes and related products, or restaurant reviews. The user may add their own information. Users may share information with others; use the map and reservations software to find and book a restaurant, and then write their own review for the bulletin board. Users may receive emails about related books or videos, read reviews, buy products and send in their own reviews. Users may watch videos and direct the program to save and mark any they want to have in their book so they can watch them again! Chat with the chef! And of course, users may use the email program to request the host to add any new recipes to the book.

The calendar program allows a user to keep track of his/her diet or plan one from week to week. A user who decides on a meal plan may order the products online or receive individualized product purchase suggestions.

### Example 5

### MYWINEBOOK

Users get wine reviews emailed to them, access to wine review archives, a program for keeping track of their own wine inventory, chat rooms that share information about specific wines, the ability to buy online, suggested trips with various “wine country” itineraries, with all the travel functions described in the host's travel planner/scrapbook above. The book links to every major vineyard. Users get email telling them about special offers or book chapters.

### Example 6

### MYPERSONALTRAINER

Users get a set of the personal trainers (life event management experts or health and fitness experts) on a host, e.g. twelve so there is one a month (or as often as a user chooses), with interactive quizzes and tools that allows the user to identify and focus on personal priorities, access to organized and extensive archives (including written content and videos), and regular personalized emails with new articles about the topics the user has chosen, for a year (or whatever length of time they choose) of focused self-empowerment. The personal power book provides each user with the ability to make a chosen time of their life, track it, compare their progress, share information with other users focused on the same issues, and have access to the records anytime from anywhere.

I claim:

1. A book created in electronic media by a user, said book comprising content selected by the user from content available through a host or a host's one or more Content Partners, in a structure designed by the user.

2. The book of claim 1, further defined as stored on a secure server.

3. The book of claim 1, wherein the content available through a host or a host's one or more Content Partners is selected from the group consisting of Web pages, audio, streaming video, and digital pictures.

4. The book of claim 1, wherein the content is selected from a group of applications consisting of MYLIFEBOOK, MYTRAVELBOOK, MYMONEYBOOK, MYFOODBOOK, MYWINEBOOK, and MYPERSONALTRAINER.

5. A method of creating a personalized book in electronic media, said method comprising:
(a) providing personal information about a user;
(b) selecting a structure for the book;
(c) selecting content of interest to the user; and
(d) manipulating the selected content into a book.

6. The method of claim 5, wherein the personal information comprises life events selected by the user.
